(19) United States
(12) Patent Application Publication
(10) Pub. No.: US 2025/0376366 A1
(43) Pub. Date: Dec. 11, 2025

(54) CONTAINER TOP CLOSURE APPARATUS, AUTOMATION SYSTEM AND RELATED METHODS

(71) Applicant: PSR Automation, Inc., Shakopee, MN (US)

(72) Inventors: David R. Ramnarain, Shakopee, MN (US); Christopher D. Ramnarain, Shakopee, MN (US); Brian D. Ramnarain, Shakopee, MN (US)

(21) Appl. No.: 18/737,505

(22) Filed: Jun. 7, 2024

(51) Int. Cl. B67B 3/20; B67B 3/26

(52) U.S. Cl. CPC B67B 3/2093; B67B 3/2053; B67B 3/261; B67B 2201/12

(57) ABSTRACT

Systems, methods, and apparatus are disclosed herein for assembling a container cap to a container, which utilizes one or more independently operated torque limiter assemblies for securing a container top to a container. A packaging system for assembling a container can include chuck assemblies, torque limiter assemblies, and a controller. The controller can be configured to command each chuck assembly and/or torque limiter assembly independently from other assemblies within the packaging system. Threads of the container top and the corresponding attachment component can be properly orientated and aligned independently of other container tops and corresponding attachment components prior to securing action, such as to preclude each attachment component from being over-tightened or under-tightened relative to the respective container.

### TECHNICAL FIELD

The present disclosure relates generally to packaging equipment. More particularly, examples provided herein relate to an apparatus, system and method for dynamically applying top closures to containers.

### BACKGROUND

Many industries rely on packaging equipment to provide efficient and reliable methods for sealing containers, such as bottles, to preserve product integrity and ensure consumer satisfaction. Traditional closure application processes often involve manual labor or semi-automated machinery, which can be time-consuming, labor-intensive, and prone to errors. Additionally, variations in container size, shape, and closure type pose challenges for achieving consistent and uniform closure application across different products.

Plastic bottles are an increasingly important form of packaging. In manufacturing plants specializing in filling liquid products into a bottle, it is usually common practice to place some type of cover (e.g., a cap, lid, and/or seal) on the bottle to prevent leakage, contamination of product, etc. The process of loading, filling, and capping a bottle as well as packaging of the final product (e.g., putting on a protective cover) can be performed through an assembly line.

Application of top closures of spray bottles (e.g., bottles capable of squirting, spraying, and/or misting fluids) are a type of container that is particularly challenging to automate. Spray bottles can be used to dispense cleaners, cosmetics, and chemical specialties through trigger-style actuators, pump-style tops, and/or rubber bulbs. For example, a pump top can draw liquid up a siphon tube from the bottom of the bottle and force the liquid out a nozzle. For example, spray bottles can use a positive displacement pump acting directly on the fluid. Depending on the sprayer, the nozzle can or cannot be adjustable, so as to select between squirting a stream, aerosolizing a mist, or dispensing a spray.

Automatic packaging/assembly procedures can be hampered when a sprayer pump must be inserted into a bottle. A sprayer pump is a special component fitted on a bottle allowing for the liquid in the bottle to be pressurized and “sprayed”. Sprayer pumps can generally include a body, handle, tube, pump, and/or nozzle. For example, spray bottles generally include a container having a threaded opening at the top that can be coupled (e.g., detachably coupled) to a threaded cap integrally formed with a pump mechanism. The pump mechanism can include a tube extending from the pump mechanism to the bottom of the container (e.g., to draw liquid). The sprayer pump can function as the cover of the bottle.

Automatic capping machines have typically not been used with spray bottles because of the difficulty in positioning the cap, particularly when a tube extends from the cap. A particular problem with automatically inserting sprayer pumps into a bottle is the sprayer pump tube commonly becomes bent during manufacture, and/or misses the opening on the bottle entirely during insertion (e.g., as the bottle opening can be restrictive in size). While the sprayer pump tube can be straight at the top of the pump assembly, it can bend at the bottom of the tube (e.g., to improve liquid draw from the bottom of the bottle). Linear mechanical systems, in which the machine is capable of only a single up/down movement and has no feedback about the current configuration of the sprayer pump or tube can be unable to apply such tops. This has led to manufacturers using manual labor or very complex machinery to insert the sprayer pump and other container tops accurately, which can drive up costs especially during small production runs.

Automatic capping machines can apply inconsistent torque when fastening a threaded cap portion to the threaded opening of the container. For example, there can be inconsistent alignment of the threads of the cap portion with respect to the threaded opening of the container, which can lead to over torque or under torque issues. When the cap portion undergoes an over torque event with respect to the threads of the cap portion being over tightened with respect to the threaded opening of the top of the container, the cap portion and/or the top of the container portion can be damaged, cracked and/or result in dust formation from material breakdown, which is not suited for operation in sterile or clean room applications. When the cap undergoes an under torque event, such that the cap portion is under tightened with respect to the threaded opening of the top of the container, the product inside the container is not properly sealed and is prone to leakage.

Therefore, there is a need for a more automated and adaptable solution for applying top closures to containers, capable of handling various container configurations and closure types with high efficiency and accuracy and proper alignment of the threaded cap portion to the threaded opening of the container for proper sealing.

### SUMMARY

Systems, methods, and apparatus are disclosed herein for assembling a container. In particular, embodiments of the present disclosure provide for independently operated torque limiter assemblies for securing a container top to a container. In some preferred aspects, a threaded container cap portion to a threaded top of the container having an opening.

In a feature and embodiment, torque can be independently applied to container tops by each torque limiter assembly, allowing for precise adjustment and control while mitigating risks associated with overtightening. For example, determining the precise chuck orientation provides for safe automation without damage to the container top and/or container.

In a feature and embodiment, operational settings and parameters can be adjusted and recorded in a controller. In some implementations, the controller can automate refinements to the operation of the packaging system based on feedback data.

In an embodiment, a packaging system for assembling a container comprises a chuck assembly, a torque limiter assembly, and a controller communicatively coupled to the chuck assembly and the torque limiter assembly. The chuck assembly includes a pneumatic motor. Operation of the pneumatic motor causes the chuck assembly to grip or release a container top. The torque limiter is coupled to the chuck assembly and includes a servo motor and an encoder. Operation of the servo motor causes rotation of the chuck assembly. The controller is configured to command the chuck assembly and the torque limiter assembly to perform one or more of the following: grip the container top using the chuck assembly; receive, from the encoder, orientation data associated with the chuck assembly; determine, based on the orientation data, an orientation of an attachment component of the container top relative to a corresponding attachment component of the container; align the attachment component of the container top and the corresponding attachment component of the container based on the orientation of the attachment component by rotating the chuck assembly using the torque limiter assembly; and secure the container top to the container by rotating the chuck assembly using the torque limiter assembly such that torque applied to the container top remains below a torque threshold.

In one aspect, the packaging system includes a second chuck assembly and a second torque limiter assembly coupled to the second chuck assembly. The second torque limiter assembly is configured to rotate the chuck assembly. The controller is configured to command the second torque limiter assembly independently from the torque limiter assembly.

In one aspect, the encoder is an absolute encoder. The orientation data can indicate one of a plurality of possible orientations of the chuck assembly.

In one aspect, the controller is configured to receive feedback data associated with the securement of the container top to the container; and adjust the torque threshold based on the feedback data.

In one aspect, the controller is configured to provide a graphical user interface (GUI) configured to receive the torque threshold from an operator.

In one aspect, the attachment component of the container top is a threaded portion, and the corresponding attachment component of the container is a corresponding threaded portion. Alignment of the threaded portion of the container top and the corresponding threaded portion of the container can comprise rotating the chuck assembly in a direction associated with unthreading (e.g., counterclockwise).

In some preferred aspects, the command to align the attachment component of the container top and the corresponding attachment component of the container based on the orientation of the attachment component by rotating the chuck assembly using the torque limiter assembly includes consideration of the proper alignment of the threaded cap portion to the threaded opening of the container, such that the chuck assembly using the torque limiter assembly may operate in a reverse direction relative to the command to secure. In some aspects, the reverse direction of the chuck assembly occurs until a preset position is achieved between the threaded cap portion and the threaded opening of the container.

In one aspect, the controller is configured to receive feedback data associated with the orientation data of the container top to the container; and align the attachment component of the container top and the corresponding attachment component of the container based on the orientation of the attachment component by rotating the chuck assembly using the torque limiter assembly. In some preferred aspects, the chuck assembly is rotated in a reverse direction to obtain proper alignment, wherein the reverse direction is an opposite rotational direction relative to the direction for securing the attachment component of the container top and the corresponding attachment component of the container. In some other preferred aspects, the chuck assembly is rotated in a same rotational direction as the securing rotational direction to obtain proper alignment, such that the rotational direction for securing the attachment component of the container top and the corresponding attachment component of the container includes additional rotations of the chuck assembly after proper alignment is obtained.

In one aspect, the container top is a sprayer cap including a diptube. The packaging system can include a diptube guide assembly for directing the diptube into the container.

In an embodiment, a method for assembling a container, comprises: griping a container top using a chuck assembly by operating a pneumatic motor associated with the chuck assembly; positioning the container top proximal to the container; receiving orientation data associated with the chuck assembly from an encoder; determining, based on the orientation data, an orientation of an attachment component of the container top relative to a corresponding attachment component of the container; aligning the attachment component of the container top and the corresponding attachment component of the container based on the orientation of the attachment component by rotating the chuck assembly through operating a servo motor associated with a torque limiter assembly selectively coupled to the chuck assembly; and securing the container top to the container by operating the servo motor associated with the torque limiter assembly to rotate the chuck assembly such that torque applied to the container top remains below a torque threshold.

In one aspect, the torque limiter assembly is configured to rotate the chuck assembly independently from a second chuck assembly.

In one aspect, the encoder is an absolute encoder, and the orientation data indicates one of a plurality of possible orientations of the chuck assembly.

In one aspect, the method includes receiving feedback data associated with securing the container top to the container and adjusting the torque threshold based on the feedback data.

In one aspect, the method includes receiving the torque threshold from a graphical user interface (GUI).

In one aspect, the attachment component of the container top is a threaded portion, and the corresponding attachment component of the container is a corresponding threaded portion.

In one aspect, aligning the threaded portion of the container top and the corresponding threaded portion of the container comprises rotating the chuck assembly counterclockwise.

In one aspect, the container top is a sprayer cap including a diptube. The method can further include guiding the diptube into the container using a diptube guide assembly.

In an embodiment, an apparatus for assembling a container comprises a support frame including a first container top applicator and a second container top applicator. The first container top applicator and the second container top applicator are configured to operate independently. A (e.g., each) container top applicator includes a chuck assembly and a torque limiter assembly. The chuck assembly includes a pneumatic motor. Operation of the pneumatic motor causes the chuck assembly to grip a container top positioned proximal to the chuck assembly. The torque limiter assembly includes a servo motor and an encoder. The torque limiter assembly is coupled to the chuck assembly such that operation of the servo motor causes rotation of the chuck assembly.

In one aspect, the encoder is an absolute encoder configured to provide orientation data indicating one of a plurality of possible orientations of the chuck assembly.

In one aspect, the chuck assembly includes jaws structured to selectively receive a portion of the container top.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof can be more completely understood in consideration of the following detailed description of various embodiments in connection with the accompanying figures.

FIG. 1 depicts a flow chart diagram of a method of insertion of uniquely shaped packaging elements, according to certain aspects of the present disclosure.

FIG. 2 depicts a front end section of a packaging system, according to certain aspects of the present disclosure.

FIG. 3 depicts a side view of a packaging system, according to certain aspects of the present disclosure.

FIG. 4 depicts an elevated view of a cap transfer and support rake, according to certain aspects of the present disclosure.

FIG. 5 depicts an elevated view of a diptube grabber assembly, according to certain aspects of the present disclosure.

FIG. 6-11 depicts a diptube being inserted into a container, according to certain aspects of the present disclosure.

FIG. 12 depicts a side view of a packaging system, according to certain aspects of the present disclosure.

FIG. 13 depicts a flow chart of an example method of insertion of uniquely shaped packaging elements, according to certain aspects of the present disclosure.

FIG. 14 depicts a front corner profile end section of a packaging system, according to certain aspects of the present disclosure.

FIG. 15 depicts a front corner profile end section of a packaging system, according to certain aspects of the present disclosure.

FIG. 16 depicts an elevated view of a diptube assembly and transfer device, according to certain aspects of the present disclosure.

FIG. 17 depicts a perspective view of a torque limiter assembly and a chuck assembly, according to certain aspects of the present disclosure.

FIG. 18 depicts a perspective view of a series of torque limiter assemblies and chuck assemblies, according to certain aspects of the present disclosure.

FIG. 19 depicts a block diagram of a packaging system for assembling containers, according to certain aspects of the present disclosure.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The present disclosure provides examples for use in automated application of container tops, such as for spray bottles. Examples enable a variety of container tops to be individually applied and tightened to bottles in such a way as to reduce risks of under-tightening, over-tightening, and/or cross-threading when tightening the container top onto the bottle.

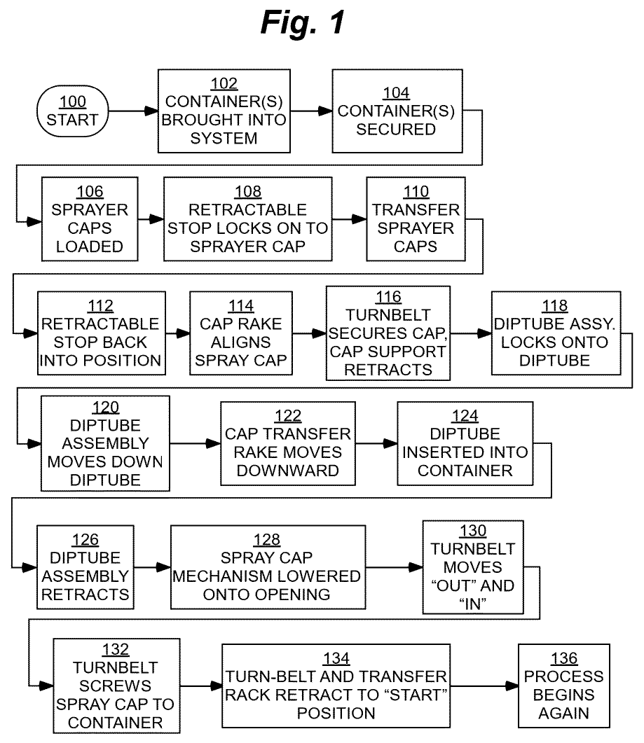

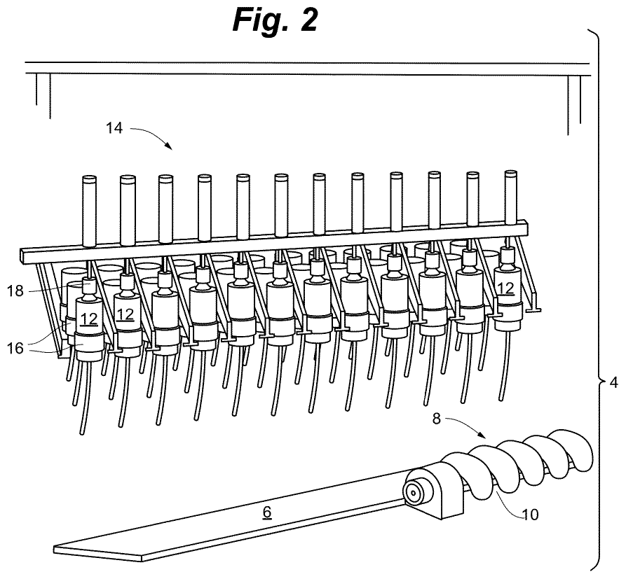

With continued reference throughout this discussion to FIG. 1, a flow chart diagram of an example method of insertion of uniquely shaped packaging elements is depicted. While the present discussion is given with respect to placing spray cap mechanisms within bottles, it is fully contemplated embodiments of the present disclosure can be extended to most any packaging element and methods of packaging elements. For example, although FIG. 1 is described with regard to element numbers depicted in FIGS. 2-12, and 14-16, it should be understood that alternative elements can be used.

With reference to FIG. 2, a front end section of an example packaging system 4 is depicted. Conveyor 6 can route containers 2 (e.g., a container) to timing screw 8. Containers 2 can be held in place in a predetermined location by timing screw 8. Conveyor 6 can be a belt conveyor including two or more pulleys, with a continuous loop of material (e.g., the conveyor belt rotating about them). Each of the pulleys can be powered, for example to move the belt and containers 2 on the belt forward. In examples where one pulley is powered, the powered pulley can be referred to as the drive pulley and the unpowered pulley can be referred to as the idler.

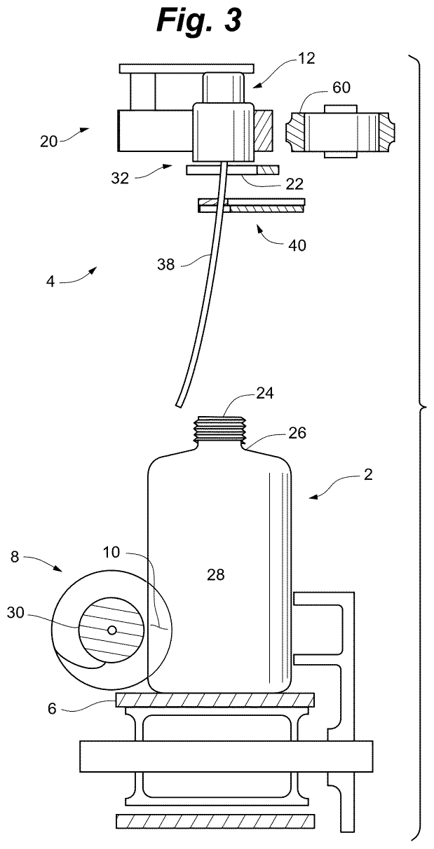

With reference to FIG. 3, a side view of an example packaging system 4 is depicted. Timing screw 8 can ensure containers 2 do not move during operation of packaging system 4. Timing screw 8 can be used to move containers 2 by a rotating helical flighting. For example, containers 2 can be moved along axis of rotation 30. In some aspects, the flighting can be uncased (e.g., as shown). Timing screw 8 can rotate and, in doing so, can move containers 2 down along axis 30 with containers 2 within pocket 10 (e.g., which can hold each container 2 at an equidistant location from one another). The distance of pocket 10 can coincide with the distance between each spray cap mechanism 12.

Referring to FIG. 1, at 100 an example method for container top closure automation can be performed. At 102, a container (e.g., containers 2) can be introduced into a packaging system. containers 2 (e.g., a container) are brought into packaging system 4 along conveyor 6. Containers 2 can be input into packaging system 4, for example, in predetermined groups. For purposes of the present discussion, one or more of the following conditions can be observed. Containers 2 can be loaded into packaging system 4 in groups of twelve. Containers 2 can have a neck 26 narrower than body 28 and a mouth/container opening 24. Containers 2 can be made of glass, clay, plastic, or other impervious materials, and can be used to store liquids (e.g., water, milk, soft drinks, beer, wine, cooking oil, medicine, shampoo, ink, etc.).

At 104, containers 2 can be secured, for example, in predetermined locations. Input containers 2 can be held in place in a predetermined location by timing screw 8 (e.g., as shown in FIG. 3). The position of a (e.g., each) container 2 can be determined independently. In examples, sensors (e.g., position sensors, optical sensors) can be used to determine when a predetermined location has been reached (e.g., such that the containers 2 should be secured).

At 106, sprayer caps can be loaded. A supply of spray cap mechanisms 12 can be loaded into the rear of packaging system 4, for example, in a sprayer magazine 14. Spray cap mechanisms 12 can be loaded at any time throughout the operation of packaging system 4, such that it should be appreciated that the loading of sprayer caps at 106 can be performed at different times relative to the operations of FIG. 1 (e.g., its position should not be considered limiting). Spray cap mechanisms 12 can be divided into channels 16 within sprayer magazine 14.

At 108, retractable stop locks can be applied to spray caps. For example, gravity can force spray cap mechanisms 12 through channel 16 until spray cap mechanisms 12 are eventually held in place by retractable stop 18. Retractable stop 18 can be pneumatically controlled. Thus, when spray cap mechanisms 12 encounter retractable stop 18 a positive pressure can be provided to keep spray cap mechanisms 12 in place until a transfer rake can take them.

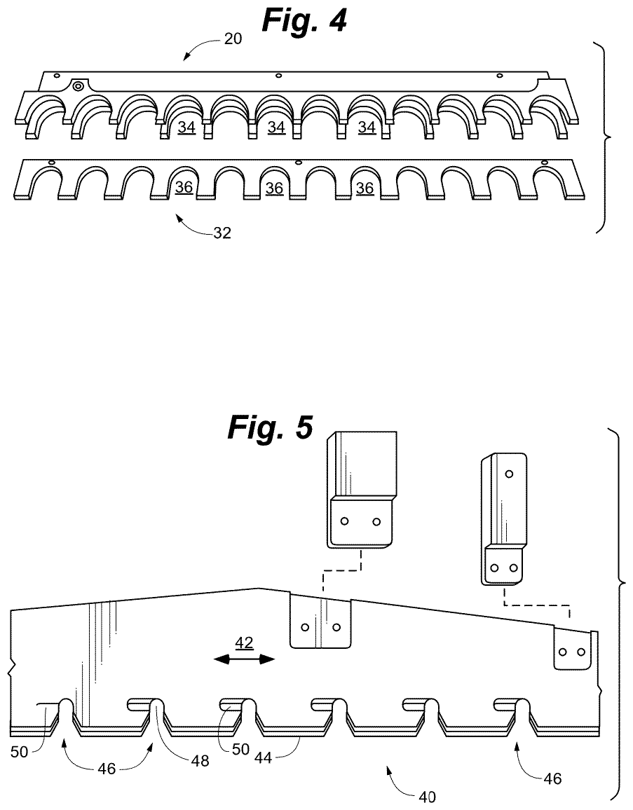

With reference to FIG. 4, an elevated view of an example cap transfer rake 20 and an example cap support rake 32 are detected. Cap transfer rake 20 and cap support rake 32 can transport spray cap mechanisms 12 to a location (e.g., a predetermined location). For example, cap transfer rake 20 and/or cap support rake 32 can transport spray cap mechanisms 12 to be above and aligned with a respective containers 2 (e.g., center 22 of the spray cap mechanism 12 can be aligned above container openings 24). Each spray cap mechanism 12 can be held within spray cap holder 34, for example, where the bottom of spray cap mechanism 12 is held and supported by support holder 36. Support holders 36 can be structured to allow enough room for diptubes 38 to pass through but small enough to allow spray cap mechanisms 12 to rest easily (e.g., upon the top of cap support rake 32).

Referring again to FIG. 1, at 110, spray caps can be transferred. For example, once containers 2 are held in place by timing screw 8, retractable stop 18 can retract allowing a predetermined number of spray cap mechanisms 12 to transfer to cap transfer rake 20. Cap transfer rake 20 can slide up and/or grasp the front row of spray cap mechanisms 12.

At 112, retractable stop 18 can move to prevent remaining spray cap mechanisms 12 from entering cap transfer rake 20. For example, retractable stop 18 can move back (e.g., return) to its original position. Cap transfer rake 20 can hold spray cap mechanisms 12 firmly in place.

At 114, the cap rake can align with spray caps. For example, cap transfer rake 20 and/or cap support rake 32 can transport spray cap mechanisms 12 above and aligned with a respective container 2 (e.g., center 22 of the spray cap mechanism 12 can be aligned above container openings 24).

At 116, a turn-belt can secure a cap and the cap support can retract. For example, turn-belt 60 can move inward toward spray cap mechanisms 12 until turn-belt 60 contacts spray cap mechanisms 12 (e.g., preventing spray cap mechanisms 12 from moving while cap support rake 32 retracts).

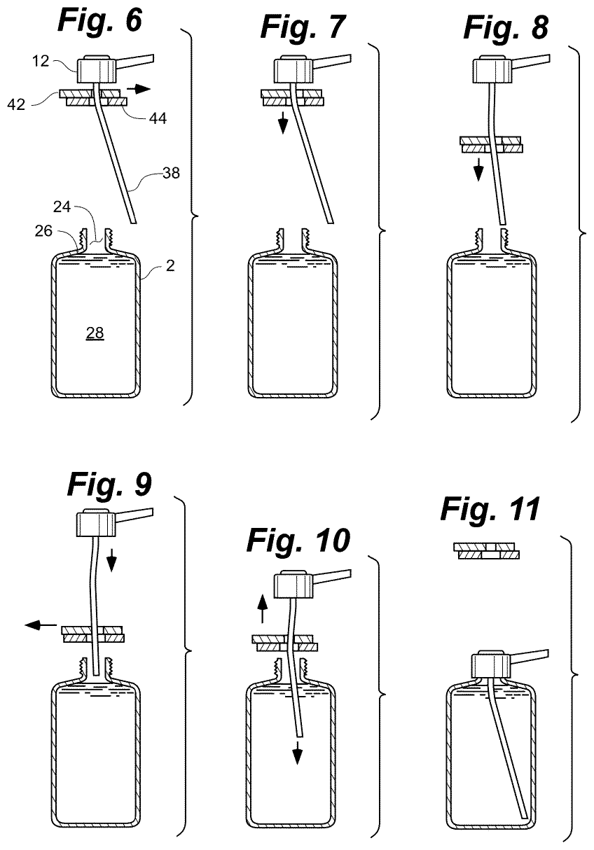

With reference to FIG. 5, an elevated view of an example diptube grabber assembly 40 is depicted. Diptube grabber assembly 40 can generally include a sliding top plate 42 and a stationary bottom plate 44. Top plate 42 and/or bottom plate 44 can have V-shaped diptube slots 46 in which to receive diptubes 38. V-shaped slot 46 can enable centering of diptube 38, for example, by forcing diptube 38 into narrow recess 48. Diptube 38 can be captured and held in place by sliding top plate 42 to the side and capturing diptube 38 within slot 50. In examples, cap transfer rake 20, cap support rake 32, and/or diptube grabber assembly 40 can be operated by electrical pneumatics and/or hydraulics. With reference to FIGS. 6-11, an example method of inserting a diptube 38 into a container 2 is depicted.

Referring again to FIG. 1, at 118, a diptube assembly can lock onto a diptube. For example, diptube grabber assembly 40 can move inward toward diptubes 38 being held in place by cap transfer rake 20 and grasps the upper portion of each diptube 38 (e.g., as shown in FIGS. 6 and 7). In examples, a (e.g., each) diptube can be associated with a respective spray cap mechanism 12.

At 120, a diptube can be manipulated (e.g., moved) by a diptube grabber assembly. Diptube grabber assembly 40 can, while holding diptubes 38 between top plate 42 and bottom plate 44, move downward (e.g., as shown in FIGS. 8 and 9). For example, diptube grabber assembly 40 can move downward until diptube grabber assembly 40 is approximately one inch from the bottom of diptube 38. The movement of assemblies and mechanisms relative to each other can be determined by sensors and/or be determined based on dimensions of containers 2. Manipulation/movement by diptube grabber assembly 40 can cause diptube 38 to straighten (e.g., as shown in FIG. 9), easing entry of diptube 38 into container opening 24 of containers 2.

At 122, cap transfer rake 20 can be moved downward and/or diptube grabber assembly 40 can move upward. In examples, a single system or subsystem can be actuated/moved (e.g., as opposed to movement of both cap transfer rake 20 and diptube grabber assembly 40).

At 124, the diptube can be inserted into the container. For example, diptube 38 can be inserted into container 2, resulting from the movement of cap transfer rake 20 and/or diptube grabber assembly 40 at 122.

At 126, the diptube grabber assembly can retract. For example, once diptube grabber assembly 40 has inserted diptube 38 in container 2, diptube grabber assembly 40 can retract (e.g., away from container 2).

At 128 the spray cap mechanism can be lowered into the container. For example, cap transfer rake 20 can (e.g., continue to) move downward, for example, until spray cap mechanism 12 reaches container opening 24.

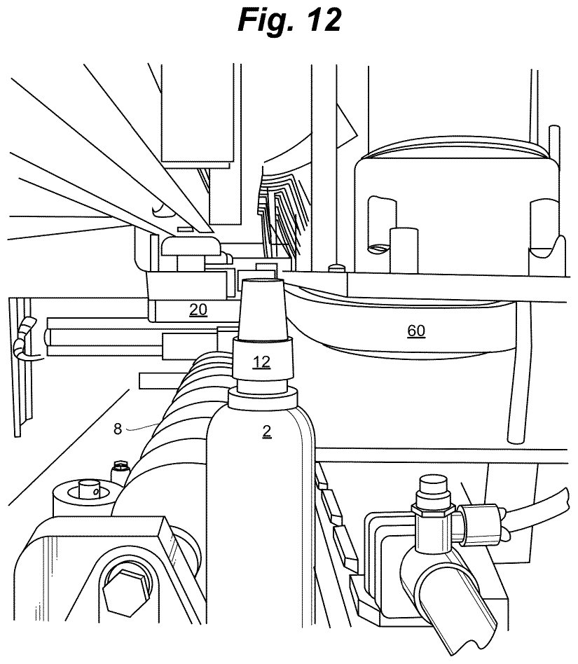

With reference to FIG. 12, a side view of an example packaging system 4, including turn-belt 60 is depicted, according to an embodiment.

With continued reference to FIG. 1, at 130, turn-belt 60 can move to release spray cap mechanisms 12 onto containers 2 before retracting.

At 132, turn-belt 60 can move in a first direction causing spray cap mechanisms 12 to rotate in a direction opposite to the internal threads on spray cap mechanisms 12. Turn-belt 60 can (e.g., then) move in a second direction (e.g., the opposite direction) to fasten (e.g., screw) spray cap mechanisms 12 to containers 2. This dual direction action can prevent cross-threading.

At 134, after spray cap mechanisms 12 are threaded onto containers 2, turn-belt 60 and cap transfer rake 20 can retract. The closed containers 2 can be removed from packaging system 4 via motorized conveyor 6.

For purposes of the present disclosure, it is assumed spray cap mechanisms 12 are already present/loaded in sprayer magazine 14. For example, the example method described in FIG. 1 can automatically insert the sprayer pumps into a container 2 (e.g., without sorting the sprayer pumps). Containers 2 can be loaded into packaging system 4 via motorized conveyor 6 and timing screw 8. After a (e.g., each) cycle, the method can be repeated, for example by returning to 100.

The example method of FIG. 1 can be fully automated and implemented to a manufacturing line with minimal complexity and without excessive cost.

Many different types of bottles and sprayers exist. Packaging system 4 can be calibrated for each type of bottle. For example, an end user can make bottle and sprayer pump specific adjustments (e.g., so the machine functions optimally). These adjustments can be associated with accommodating particular dimensions or properties (e.g., resistances) of the desired container (e.g., bottle/sprayer).

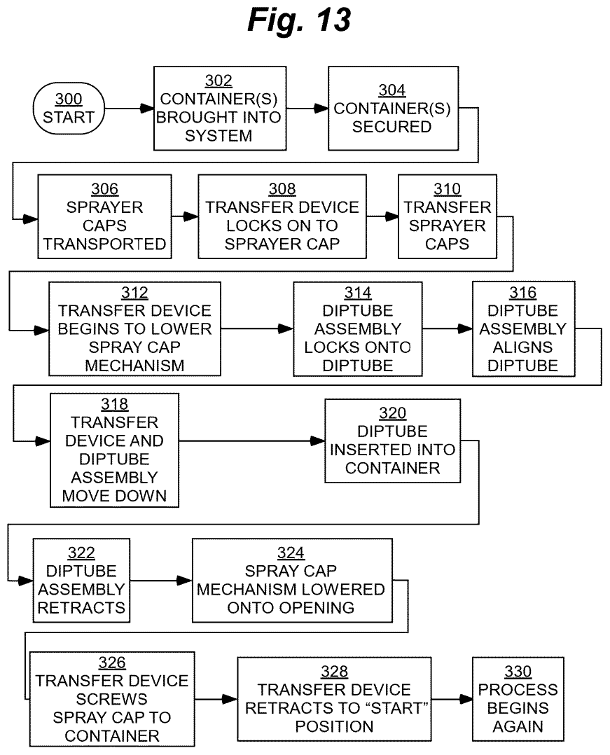

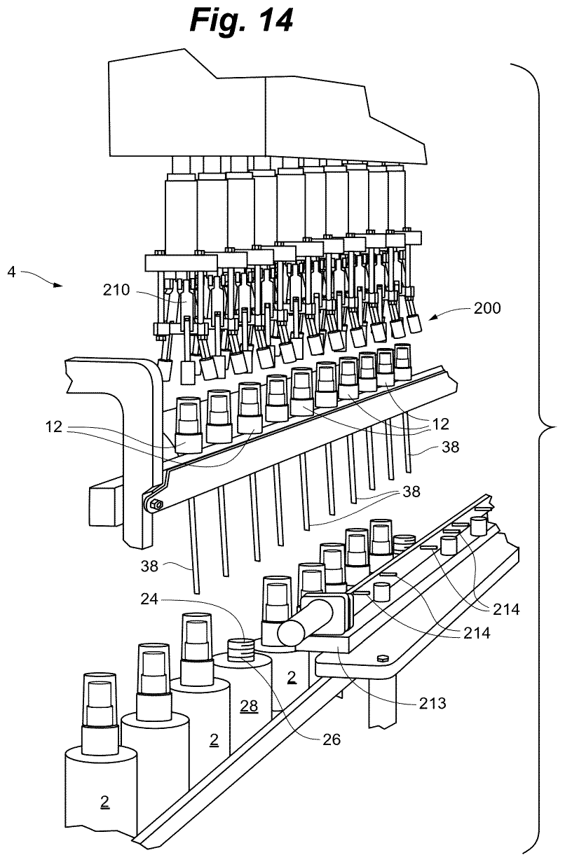

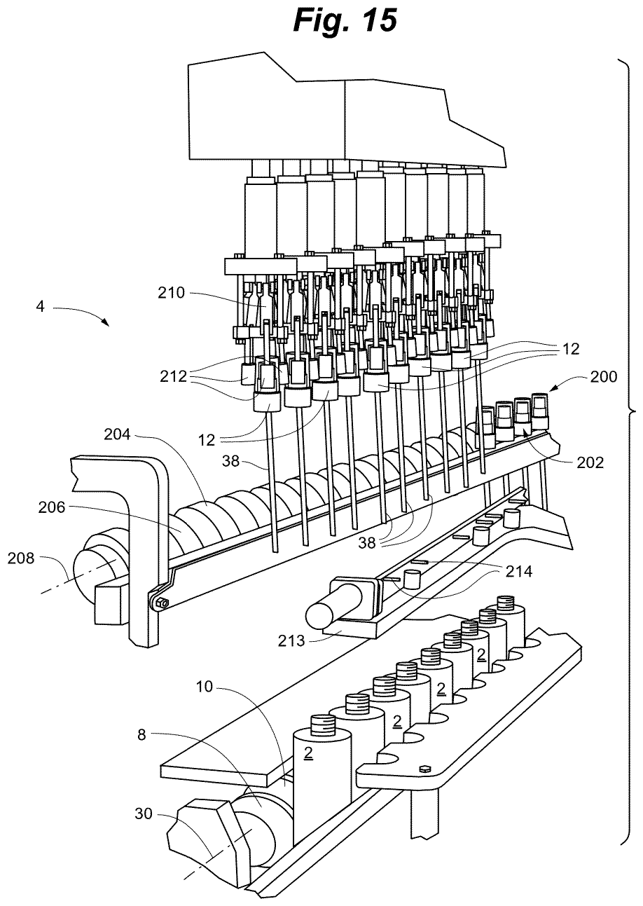

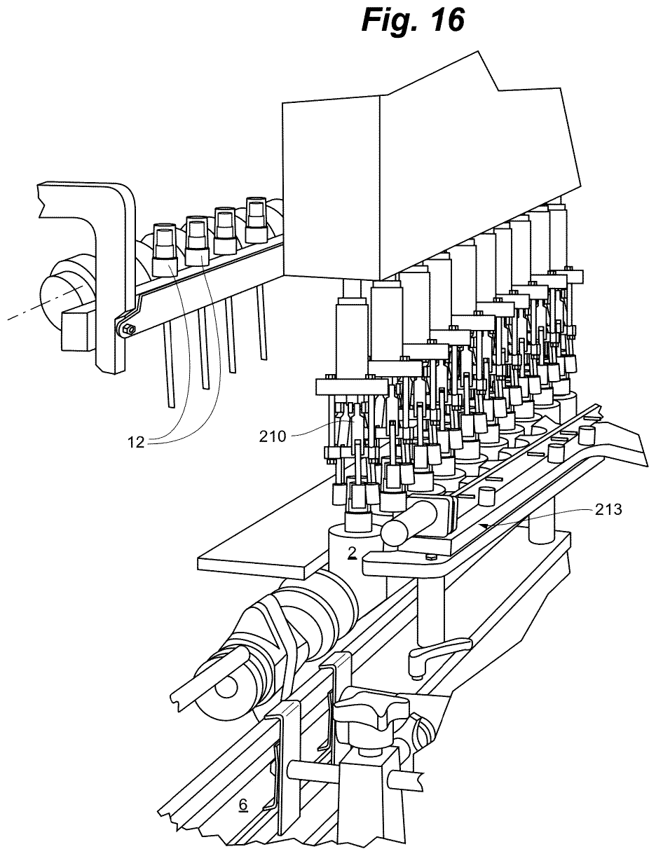

With continued reference throughout this discussion to FIG. 13, a flow chart of an example method 300 for insertion of uniquely shaped packaging elements is depicted. FIGS. 14 and 15 each depict example front corner profile end sections of a packaging system. FIG. 16, depicts an example diptube 38 being inserted into a container 2.

Referring to FIG. 13, at 302, containers 2 can be brought into packaging system 4 (e.g., as depicted in FIGS. 14-16). For example, containers 2 can be moved along conveyor 6. Containers 2 can be input into packaging system 4 in predetermined groups (e.g., groups of 3, 5, 10, 12, etc.). For purposes of the present discussion regarding the example depicted in FIG. 13, one or more of the following conditions can be implemented. Containers 2 can be loaded into packaging system 4 in groups of ten. Containers 2 can have a neck 26 narrower than body 28 and a mouth/container opening 24. Containers 2 can be made of glass, clay, plastic or other impervious materials, and can be used to store liquids, such as water, milk, soft drinks, beer, wine, cooking oil, medicine, shampoo, ink, etc.

At 304, introduced containers can be secured (e.g., individually or collectively). For example, conveyor 6 can route containers 2 to timing screw 8. Containers 2 can be held in place in a location (e.g., predetermined location) by timing screw 8 (e.g., as shown in FIG. 15). Conveyor 6 can be a belt conveyor, for example, that includes two or more pulleys, with a continuous loop of material (e.g., the conveyor belt rotating about them). One or more of the pulleys can be powered, moving the belt and containers 2 on the belt forward. A (e.g., each) powered pulley can be referred to as a drive pulley while a (e.g., each) unpowered pulley can be referred to as an idler.

As shown in FIG. 15, timing screw 8 can ensure containers 2 do not move during operation of packaging system 4. Timing screw 8 can be used to move containers 2, for example, by a rotating helical flighting. Containers 2 can be moved along axis of rotation 30. As shown in FIG. 15, the flighting is not encased. Timing screw 8 can rotate and, in doing so, can move containers 2 down along axis 30 with containers 2 within pockets 10. Pockets 10 can hold containers 2 equidistant from one another. A distance between each container within pockets 10 can coincide with the distance between each spray cap mechanism 12.

Referring again to FIG. 13, at 306, a supply of spray cap mechanisms 12 can be loaded into rear 200 of packaging system 4, for example in a sprayer transport 202. Spray cap mechanisms 12 can be loaded at any time throughout the operation of packaging system 4 (e.g., the location of 306 is not limited to its orientation as shown in FIG. 13). Spray cap mechanisms 12 can be divided into channels 204 on a second timing screw 206. Timing screw 206 can be used to move spray cap mechanisms 12, for example, by a rotating helical flighting. Spray cap mechanisms 12 can be moved along an axis of rotation 208. The flighting can be in a position where it is not encased (e.g., as shown in FIG. 15). Timing screw 206 can rotate and, in doing so, can move spray cap mechanisms 12 down along axis 208 with spray cap mechanisms 12 within pockets 204. Pockets 204 can hold spray cap mechanisms 12 equidistant from one another. A distance between each spray cap mechanisms 12 within pockets 204 can coincide with the distance between each container 2.

Timing screw 206 can transfer spray cap mechanisms 12 into timing screw 206 until all pockets 204 hold a spray cap mechanism 12. In examples, some pockets 204 can be configured to not hold a spray cap mechanism 12. In examples, all pockets 204 can hold a spray cap mechanism 12 (e.g., for packaging system 4 to operate efficiently). Packaging system 4 can operate more efficiently if each pocket 204 has a spray cap mechanism 12 within pocket 204 to ensure all containers are properly capped.

At 308, during a transfer process to properly place spray cap mechanisms 12 within containers 2, spray cap mechanisms 12 can be grasped by transfer device 210. Transfer device 210 can be pneumatically controlled. Thus, when spray cap mechanisms 12 are grasped by transfer device 210 a positive pressure is provided to keep spray cap mechanisms 12 in place. Transfer device 210 is shown having three fingers 212 in which to grasp and hold spray cap mechanisms 12 in place; however, one or more fingers 212 can be used to grasp spray cap mechanisms 12 without departing from the spirit of the invention.

At 310, once containers 2 are held in place by timing screw 8, transfer device 210 can move spray cap mechanisms 12 over container openings 24, for example, as shown in FIG. 15.

At 312, transfer device 210 can lower diptubes 38 (e.g., coupled to the underside of spray cap mechanism 12) into container openings 24 of containers 2. During the lowering process, diptube assembly 213 can extend inward towards the lowering diptubes 38 and accepts diptubes 38 within apertures 214 located on one side of diptube assembly 213.

At 314, diptube assembly 213 can align diptube 38 over container opening 24, for example, by insuring diptube 38 remains substantially straight to insure proper diptube insertion to container opening 24.

At 316, diptube assembly 213 can lock onto diptubes 38.

At 318, transfer device 210 and diptube assembly 213 can move downward to insert diptube 38 within container opening 24.

With reference to FIG. 16, an elevated view of an example diptube assembly and transfer device. A (e.g., each) diptube 38 can be held within diptube assembly 213 (e.g., where the sides of spray cap mechanism 12 is held and supported by transfer device 210). At 316, diptube assembly 213 can move inward toward diptubes 38 associated with each of spray cap mechanism 12 being held in place by transfer device 210 and grasps the upper portion of each diptube 38. Diptube 38 can be captured within apertures 214 and held in place. Diptube assembly 213 can be operated by electrical pneumatics and/or hydraulics.

Referring again to FIG. 13, at 318, diptube assembly 213 can (e.g., while holding diptubes 38) move downward, for example, until diptube assembly 213 is approximately one inch from the bottom of diptube 38. This action by diptube assembly 213 can cause diptube 38 to straighten (e.g., as shown in FIG. 9), easing entry of diptube 38 into container opening 24 of containers 2.

At 320, the combination of transfer device 210 moving downward (e.g., at 318) while diptube assembly 213 moves downward, can cause diptube 38 to be inserted into container 2.

At 322, once diptube assembly 213 has inserted diptube 38 in container 2, diptube assembly 213 can retract away from container 2.

At 324, Transfer device 210 can (e.g., continue to) move downward, for example, until spray cap mechanism 12 reaches container opening 24.

At 326, transfer device 210 can rotate and screw spray cap mechanisms 12 onto openings 24, securing spray cap mechanisms 12 onto containers 2.

At 328, after spray cap mechanisms 12 are completely threaded onto containers 2, transfer device 210 can retract and the closed containers 2 can be removed from packaging system 4 via motorized conveyor 6.

The process can be repeated at 330 by returning to 300.

Some packaging systems can be controlled on a per station basis, where a station refers to one or more chuck units (e.g., container top applicators) that are commonly controlled, for example by being associated with (e.g., sharing) a motor, an orientation pin, and/or a belt. Such packaging system orientations can require the packaging system to incorporate mechanical clutches, torque limiters, and/or mechanical chuck control mechanism(s) for position/orientation that are common to all chuck units in the station (e.g., rather than individual chuck units).

Station-based packaging systems, for example that comprise commonly controlled chuck units, can encounter inconsistent torque across motors and/or be unable to precisely control chuck orientation. This lack of precision in operation and monitoring capabilities can lead to damage of the chuck mechanism and/or the container. For example, overtightening container tops can produce residue or dust from the container material (e.g., plastic) undergoing excess pressure. This residue can be unsuitable for operation in sterile or clean room settings. Further, station based packaging systems can be unable to communicate high granularity data, such as detailed metrics on a chuck specific basis, to a control system.

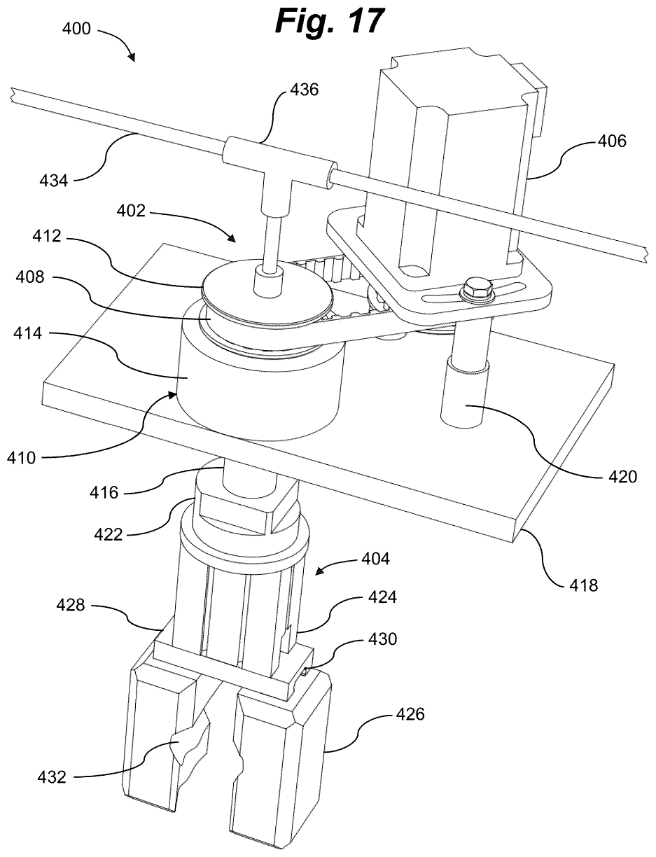

Referring to FIG. 17, a perspective view of a system 400 for picking, orienting, and securing container tops to containers is depicted, according to an embodiment. In an embodiment, system 400 is structured and configured to manipulate container tops with diptubes, sprayer pumps, finger pumps, bottle caps, and the like. System 400 includes a torque limiter assembly 402 and chuck assembly 404.

Torque limiter assembly 402 generally includes a drive belt motor 406, a drive belt 408, and a torque limiter 410. Drive belt motor-406 provides the mechanical power needed to operate torque limiter assembly 402. Drive belt motor 406 is structured to apply rotational motion to drive belt 408, which transfers the rotational motion to torque limiter 410. Drive belt 408 can be a flexible loop that transmits power from the drive belt motor 406 to the torque limiter 410. Torque limiter 410 is structured and configured to prevent the over-application of torque to chuck assembly 402 (e.g., to secure container tops without causing damage).

Torque limiter 410 includes a drive pulley 412, a torque limiter housing 414, and a shaft 416. Drive pulley 412 is selectively rotated by drive belt 408 such that it translates the rotational motion from the belt to shaft 416. Torque limiter housing 414 encases the internal components of the torque limiter (e.g., friction material, thrust bearings) protecting them from external damage and contamination. Shaft 416 configured to selectively couple and apply torque to chuck assembly 404.

In some embodiments, shaft 416 can be an inner or outer tube coupled to a corresponding tube of torque limiter within torque limiter housing 414. In some implementations, shaft 416 can include a spring to allow for vertical compensation (e.g., for aligning threads of a container top).

In some embodiments, drive belt motor 406 is a servo motor. In such embodiments, drive belt motor 406 is configured to operate electrically. For example, drive belt motor 406 can be configured to work with feedback systems (e.g., encoders) to provide precise control over position, speed, and torque. A servo motor can be programmed for different operational profiles and tasks. For example, different container and/or container cap types, which may have different thread sizes. This programmability allows for flexibility to adapt to various container tops and/or sizes without the need for manual adjustment.

In some embodiments, drive belt motor 406 is a pneumatic motor. In such embodiments, drive belt motor 406 can be configured to operate using compressed air and control can be achieved through regulating air flow and pressure. A pneumatic motor can be used in conjunction with one or more of a flow sensor, a pressure sensor, a position sensor (e.g., a linear variable differential transformers (LVDTs), a potentiometer), or a pressure regulator. For example, a flow sensor can measure flow rate of the compressed air supplied to the pneumatic motor and be used in conjunction with proportional valve(s) to modulate the air flow.

In some embodiments, the torque limiter assembly 402 is configured to implement adjustable torque settings. In some embodiments, torque limiter assembly 402 can include an auto encoder to enhance the precision and performance of the system. An auto encoder (also referred to simply as an encoder) is a sensor device that provides feedback on the position, speed, and/or direction of shaft 416. In some implementations, drive belt motor 406 can include (e.g., integrate) an encoder allowing for fine-tuning of the amount of torque applied. This fine tuning can accommodate various types of container tops such as diptubes, sprayer pumps, finger pumps, and bottle caps. In general, an encoder is integrated in embodiments with drive belt motor 406 comprising a servo motor.

In some embodiments, drive belt motor 406 can include an absolute encoder configured to provide an absolute position of shaft 416. The absolute position of shaft 416 can be determined associating a unique code with each shaft position. are crucial for applications requiring precise and reliable position data at all times, even after power loss.

In some embodiments, drive belt motor 406 can include an incremental encoder configured to provide feedback by generating pulses as shaft 416 rotates. A controller of torque limiter assembly 402 can determine the position of shaft 416 by counting generated pulses (e.g., based on a known starting position/orientation).

Incorporation of encoders in torque limiter assembly 402 provides high-resolution, real-time feedback, allowing for precise control and adjustment of the motor's position and speed. A continuous feedback loop facilitates immediate corrections, ensuring the motor operates within desired parameters, maintaining consistent torque levels. Accurate torque control is essential for preventing over-torque situations that can produce dust, for example, from the friction between container tops and containers when over tightening. Further, with precise control of torque, motors can operate more efficiently, reducing energy consumption and wear on mechanical components. This efficiency leads to longer motor life and lower maintenance costs.

Torque limiter 410 can include a safety mechanism, such as for overload protection, that disengages the drive belt 408 when a pre-set torque limit is exceeded, preventing over-tightening and potential damage.

In some embodiments, torque limiter assembly 402 can include a torque adjustment mechanism. For example, the torque adjustment mechanism can be a dial or a screw mechanism that adjusts the tension on a spring (e.g., to allow a user to set a specific torque limit). In some implementations a torque adjustment mechanism can be incorporated into torque limiter housing 414.

In some embodiments, torque limiter assembly 402 can include a slip clutch. For example a slip clutch can disengage when a set torque limit is exceeded, preventing the application of excessive force to the container top. A slip clutch can include friction discs and a spring-loaded mechanism. In some implementations a slip clutch can be contained within torque limiter housing 414.

In some embodiments, torque limiter assembly 410 can include indicator(s) configured to provide an indication when the torque limiter has been activated. For example, torque limiter housing 414 can incorporate a visual or electronic indicator to alert an operator to potential issues.

Drive belt motor 406 of torque limiter assembly 402 can be secured to a support plate 418 (e.g., of a larger frame) via mounting brackets 420. Mounting brackets 420 can absorb vibrations and provide a stable base for the assembly. In some embodiments, drive belt motor 406 can be incorporated or otherwise integrated with support plate 418. In some embodiments, mounting brackets 420 may be unnecessary or an alternate coupling mechanism can be used.

Chuck assembly 404 is coupled to shaft 416 of torque limiter 402 assembly 402 via coupling 422, according to embodiments. In some embodiments, coupling 422 is configured to be selectively engaged with shaft 416. For example, coupling 422 can be a direct threaded connection or a quick-release mechanism for easy maintenance.

Chuck assembly 404 generally includes a chuck body 424 attached to jaws 426 via scroll plate 428. As illustrated, scroll plate 428 can include channel 430 along which jaws 426 can be opened and closed. In some embodiments, scroll plate 428 can be an alternate actuation mechanism depending on the type of chuck used. For example, in an independent jaw chuck, a (e.g., each) jaw can be moved by an independent chuck screw. For example, an alternate actuation/adjustment mechanism can be one or more of a cam, a set of springs, or a hydraulic system.

Jaws 426 can be structured based on a particular container top. For example, as illustrated, jaws 426 include recesses 432 that can receive a protrusion of a spray top. In some embodiments, the number and/or structure of jaws 426 can vary based on the type of chuck assembly 404 and the container top to be handled. Generally, jaws 426 are adjustable to accommodate different pump sizes and are actuated by a motor within chuck body 424.

In some preferred aspects, jaws 426 are removable from scroll plate 428, such that desired jaws 426 can be attached to scroll plate 428 in relation to the particular container top, which allows the changing of jaws 426 without necessarily having to remove the entire chuck assembly 404 for operable integration with the particular container top.

In some embodiments, chuck assembly 404 can include a pneumatic chuck that uses compressed air to clamp and release container tops. Pneumatic chucks allows for quick clamping and release, suitable for automated processes and high-speed production environments. For example, pneumatic chucks can be well suited in production lines for coupling container tops to containers.

In such embodiments, chuck body 424 includes a pneumatic motor. Compressed air can be supplied to the pneumatic motor through a controlled system. For example, in the illustrated embodiment, torque limiter assembly 402 is configured to incorporate tubing 434 to provide an air supply to chuck assembly 404. Bracket 436 can be used to share access to the compressed air supply along a common line. The pneumatic motor of chuck body 424 converts supplied air pressure into mechanical energy, providing motion to the chuck.

Jaws 426 are connected to the motor (e.g., which rotates or moves linearly) within chuck body 424 via scroll plate 428 (e.g., a linkage mechanism). The motor's motion causes jaws 426 to open or close. In some embodiments, the motor of chuck assembly 404 can manipulate jaws 426 directly.

In some embodiments, chuck assembly 404 can include a three-jaw chuck (e.g., a self-centering chuck) that has three jaws that move simultaneously when a chuck key is turned. A three-jaw chuck can be well-suited for holding round workpieces, such as bottle caps.

In some embodiments, chuck assembly 404 can include a four-jaw chuck that includes four independent jaws that can be adjusted separately. A four-jaw chuck can be used for holding irregular shaped or non-cylindrical container caps.

In some embodiments, chuck assembly 404 can include a collet chuck that includes a collet (e.g., a sleeve) to form a collar around a container top and applying a clamping force when tightened. Collet chucks can provide high precision and grip strength.

In some embodiments, chuck assembly 404 can include a hydraulic chuck that uses hydraulic pressure to clamp a container top. Use of a hydraulic chuck can provide vibration damping and high repeatability.

In some embodiments, chuck assembly 404 can include a combination chuck that combines features of different chuck types. Different types of chucks can provide the versatility needed to handle various shapes, sizes, and materials of container tops.

In some embodiments, chuck assembly 404 includes interchangeable chucks to accommodate differences between container tops. For example, chuck assembly 404 can include serrated chucks specifically designed for a particular cap finish or shape.

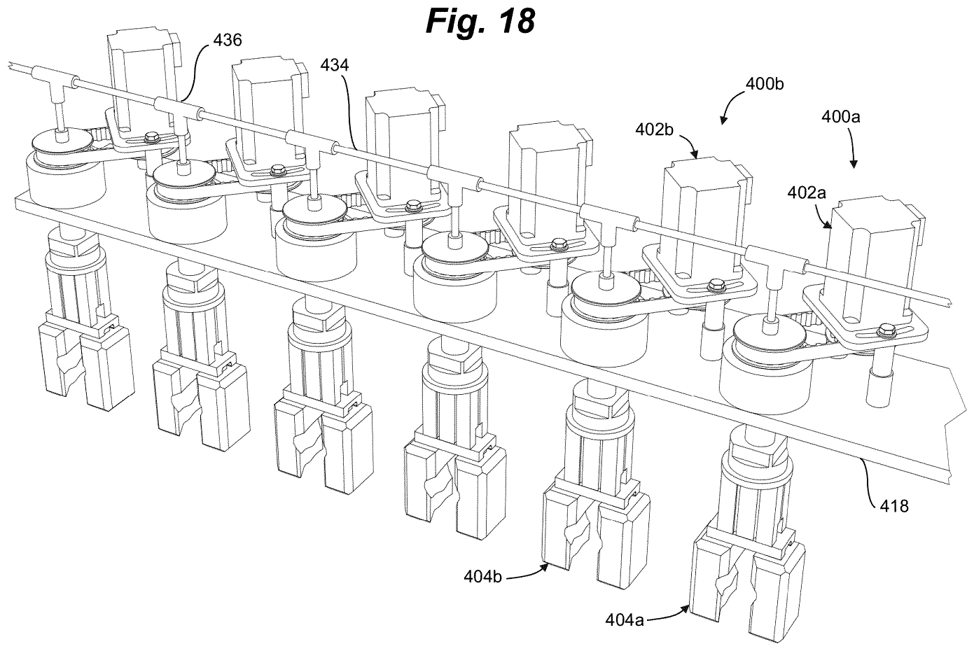

Referring to FIG. 18, a perspective view of a series systems 400 for picking, orienting, and securing container tops to containers is depicted, according to an embodiment. A (e.g., each) system 400 can include a torque limiter assembly 406 and chuck assembly 404 (e.g., as described with respect to FIG. 17). As illustrated, multiple torque limiter assembly 406 and chuck assembly 404 pairs can be coupled along a common support plate 418. Multiple systems 400 can be coupled to a common compressed air supply via tubing 434 and brackets 436.

In some embodiments, each system 400 of the series is configured to operate independently (e.g., controlled separately). In some embodiments, torque limiter assemblies 406 are configured to manipulate the rotation of chuck assemblies 404 based on encoder feedback (e.g., absolute encoder feedback). Accordingly, a series of container tops can be independently manipulated, addressing technical problems.

In some embodiments, chuck assemblies 404 can be pneumatically controlled. For example, when a container top (e.g., a spray cap mechanism 12) are grasped by jaws 426 a positive pressure is provided to keep the container top in place. A controller can determine an orientation of the container top, for example, based on sensor data from an encoder. The sensor data can provide an indication of the initial positions and orientations of system 400, a container top, and/or a container. In some embodiments, the container can be realigned (e.g., along a conveyor mechanism) such that its position/orientation is known. In such embodiments, a thread pattern of the container opening, or other coupling mechanism, can be determined. In some embodiments, the container opening can be orientation agnostic, for example, such that the container opening can be absent of directional features. In some embodiments, additional sensors can be used.

In some embodiments, a controller can, based on a determined orientation, rotate container tops prior to applying the container top to a container. For example, the controller can rotate the container top in a direction away from threads of the container top (e.g., counterclockwise) in order to properly align the threads of the container top with the corresponding threads of the container prior to attachment (e.g., clockwise rotation to screw the container top onto an opening of a container). In some embodiments, after container top(s) are completely threaded onto, or otherwise coupled to, container(s) system 400 can retract and/or reset to an initial position.

In some implementations, a controller receives input from the sensors regarding the position and orientation of the container and the container top. The controller can command the motors and/or actuators of system 400 to rotate and translate the container top. The system can rotate the top in both clockwise and counterclockwise directions to achieve proper alignment. The sensors provide continuous feedback, allowing the controller to make real-time adjustments to the position and orientation of the container top. Once aligned, the controller signals the chuck to lower the container top onto the container. The torque limiter ensures that the correct amount of force is applied to secure the container top without over-tightening (e.g., protecting both the container and the top from damage). After the top is securely fastened, the chuck releases the container top, and the container is moved to the next stage of the process (e.g., inspection, packaging). In such implementations, the speed of rotation of the container top can be adjusted by the controller.

Embodiments of the present disclosure accordingly overcome technical problems associated with use of a common belt to drive a chuck system with friction clutches and an orientation pin. Systems incorporating a common belt and/or driving mechanism can be unable to precisely control the application of container tops, leading to damage or uneven tightening across the system. For example, if the original orientation of container tops and/or containers is not constant, some container tops can be partially over tightened or under tightened based on the initial state. To avoid leakage, such systems are often operated to prefer over tightening, which can damage container tops and produce residue (e.g., dust).

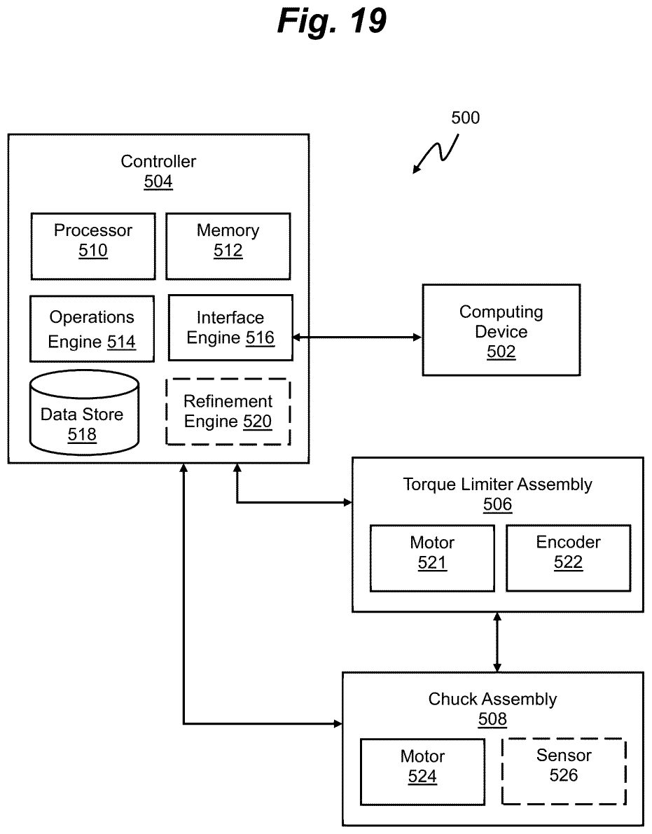

Referring to FIG. 19, a block diagram of a packaging system 500 is depicted, according to an embodiment. Packaging system 500 is configured to automatically orienting and secure container tops to containers. Packaging system 500 includes computing device 502, controller 504, torque limiter assembly 506, and chuck assembly 508. In examples, a packaging system 500 can be equipped with a series of torque limiter assemblies 506 and chuck assemblies 508 (e.g., as described with respect to FIG. 18).

Computing device 502 comprises an electronic device in communication with system 500. In an example, computing device 502 can be desktop computer, a laptop computer, tablet, mobile computing device, server, workstation, or Internet-of-things (IoT) device, among other electronic devices. Though depicted as protecting a single computing device, system 500 can, in other embodiments, include a plurality of computing devices 502, such as a networked system of devices. In embodiments, computing device 502 can be utilized by a user to interact with other components of system 500, such as controller 504, to configure packaging operations and/or obtain operations data.

Controller 504 generally comprises processor 510, memory 512, operations engine 514, interface engine 516, data store 518, and optionally, refinement engine 520. Controller 504 generally provides capabilities to create and execute a workflow for an assembly line or packaging system (e.g., system 400). In examples, controller 504 is configured to allow for adjustment of torque limiter assembly 506 and/or chuck assembly 508. For example, controller 504 can automatically adjust the speed of torque limiter assembly 506.

In an embodiment, as illustrated in FIG. 19, controller 504 is implemented on a single device, such as a server, having its own processor and memory. In embodiments, controller 504 can be a cloud-based service such that control of packaging assemblies can be distributed across a network of multiple computing devices (e.g., with each device having its own processor and memory).

Embodiments described herein include various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques.

An (e.g., each) engine can be realized in a variety of physically realizable configurations and should generally not be limited to any particular implementation exemplified herein, unless such limitations are expressly identified. In addition, an engine can itself be composed of sub-engines, each of which can be regarded as an engine in its own right. Moreover, in the embodiments described herein, each of the various engines corresponds to a defined functionality; however, it should be understood that in other contemplated embodiments, each functionality can be distributed to more than one engine. Likewise, in other contemplated embodiments, multiple defined functionalities can be implemented by a single engine that performs those multiple functions, possibly alongside other functions, or distributed differently among a set of engines than specifically illustrated in the examples herein.

Operations engine 514 is (pre) configured to process operational events and notify computing device 502 of relevant events and data. For example, operations engine 514 can act as a manager that maintains the state and progress of packaging assemblies and subassemblies throughout the packaging workflow. In such an embodiment, operations engine 514 can capture (e.g., track) the status, history, and/or metadata associated with each assembly, allowing for real-time monitoring, reporting, and analysis.

In an embodiment, operations engine 514 monitors event states and/or receives data regarding event states across packaging assemblies and systems. For example, operations engine 514 can detect or determine a data event from a first torque limiter assembly that can lead to one or many actions in a second torque limiter assembly.

In an embodiment, event detection by operations engine 514 is based on a comparison of properties associated with a specified event and obtained state data. For example, a similarity search can be conducted to determine obtained sensor data is associated with a specific incident or environmental factors.

In an embodiment, operations engine 514 is configured to coordinate workflows between identified packaging assemblies and/or systems (e.g., systems 400). For example, operations engine 514 can incorporate events, triggers, actions, and conditions, associated with operating a series of packaging systems. Correlations, associations, and links between cross-system data can be defined by a user, for example via interface engine 516, or automatically determined, for example via refinement engine 520. In an example, a user can specify that a frame coupled to torque limiter assembly 506 and chuck assembly 508 should not be retracted until a signal indicating successful application of container tops is received from other systems (e.g., torque limiter assembly and chuck assembly pairs) associated with the frame.

In an embodiment, operations engine 514 is configured to perform task assignment and allocation. In one aspect, operations engine 514 can support dynamic routing decisions that consider factors such as task priority and process constraints. For example, operations engine 514 can perform task reassignment between packaging assemblies to ensure efficient workload distribution and resource utilization. In such an example, if torque limiter assembly 506 is determined to be inoperable (e.g., broken), containers routed to a position associated with torque limiter assembly 506 can be redirected to functional torque limiter assemblies.

Interface engine 516 provides input/output capabilities of controller 504. In an embodiment, interface engine 516 can comprise an interface, such as a graphical user interface, configured to display related event topic fields and schemas and receive user input. For example, a user can define custom operational processes based on particular containers and/or container tops though an interface provided by interface engine 516.

Interface engine 516 can include graphical or text-based interfaces for defining packaging workflows (e.g., assembly operating parameters). In an embodiment, interface engine 516 generates monitoring dashboards (e.g., reporting tools and analytics capabilities) to track the performance, efficiency, and compliance of packaging workflows.

In an embodiment, interface engine 516 integrates with other systems, applications, and databases to access data, trigger events, and exchange information. For example, interface engine 516 can access external databases.

Data store 518 comprises one or more storage repositories, such as a database, logical disk space, file, or other suitable storage medium configured to store operations data. In an embodiment of a database, data store 518 can be a general-purpose database management storage system (DBMS) or relational DBMS as implemented by, for example, ORACLE, IBM DB2, Microsoft SQL Server, PostgreSQL, MySQL, SQLite, LINUX, or UNIX solutions.

In an embodiment, data store 518 can be external to controller 504. For example, data store 518 can be communicatively coupled to controller 504 over a network.

In an embodiment, controller 504 can access data store 518. In embodiments, computing device 502 is provided access to all or a subset of operations data in data store 518 (e.g., operations data applicable to a particular packaging assembly or system can be provided).

In an embodiment, a user can provide operations data to data store 518 using computing device 502. In another embodiment, operations engine 514 itself can actively gather or request event data from computing device 502, torque limiter assembly 506, or chuck assembly 508.

Optional refinement engine 520 is configured to utilize AI models to refine packaging workflows. For example, refinement engine 520 can monitor the implementation of a workflow and log the details to improve system 500 effectiveness. Process metrics of operations can allow for automated improvement and optimization of controller 504 according to an embodiment.

In examples, refinement engine 520 can implement machine learning to dynamically improve assembly line performance over time. In general, a machine learning algorithm seeks to approximate an ideal target function that best maps input variables to output variables. Refinement engine 520 can implement supervised (e.g., trained), unsupervised, or semi-supervised machine learning algorithms, for example depending on the type of data used.

In an embodiment, sensor data associated with encoder 522 or sensor 526 can be stored in data store 518 such that statistics can be gathered for later monitoring and updating purposes. If an operational parameter of an assembly is not optimal (e.g., marked as such by a user), the operational parameter can be modified.

In an embodiment, reinforcement learning can be used to implement a reinforcement learning model where refinement engine 520 determines a recommended operational parameter (e.g. the most effective trigger) based on rewards received for successful packaging operations. Over time, the model can optimize workflow element suggestions for various scenarios and properties, effectively learning from past actions.

For example, refinement engine 520 can implement a feedback loop, based on training data or produced containers, to generate a model approximating a tightening percentage by deducing structures, relationships, themes, and/or similarities present in input data. For example, rules can be extracted from the data, a mathematical process can be applied to systematically reduce redundancy, or data can be organized based on similarity. Input data can comprise one or more of container characteristics (e.g., size, position, orientation), container top characteristics (e.g., spray nozzle, presence of a diptube), process characteristics (e.g., type of fastening between the container and the container top), and packaging system characteristics (e.g., type or parameters of motors, container group size).

In examples, refinement engine 520 can compare monitored data to benchmark(s) to improve operation for a particular container or motor (e.g., to automatically evaluate ongoing performance). A benchmark can be a set of variables and/or parameters used during operation of packaging system 500.

Refinement engine 520 can apply machine learning to, for example, calibration, troubleshooting, reporting, etc. For example, refinement engine 520 can implement a benchmark for calibration. In such examples, the benchmark can include a checklist of items used to calibrate packaging system 500. For example, a calibration benchmark can include one or more of: moving a bottle belt in/out of a particular position, moving a container to a particular location (e.g., centering), adjustment of conveyor parameters, adjustment of motor parameters.

By observing data during calibration processes (e.g., through preconfigured training data or by monitoring calibration processes in operation), ideal operating parameters (e.g., an operating function) that optimally maps input variables (e.g., container and motor characteristics) to output variables (percentage of containers with successful tightening) can be determined by refinement engine 520. With advanced feedback monitoring and control capabilities, refinement engine 520 can leverage individually controlled motors 502 to deliver reliable performance and minimize the risk of defects or inconsistencies in closure application.

Torque limiter assembly 506 is configured to mediate torque applied to a container top during packaging operations. Torque limiter assembly 506 generally includes a motor 521 and an encoder 522.

Motor 521 can be controlled (e.g., with torque and speed control) independently from other motors within packaging system 500. For example, motor 521 can be tailored to the specifications and/or requirements of different container sizes, closure types, and production speeds. In an embodiment, motor 521 comprises a servo motor.

Encoder 522 can be an absolute encoder. For example, encoder 522 can provide controller 504 with an indication of a precise orientation of chuck assembly. This can enable system 500 to adapt to varying container and closure specifications while maintaining optimal sealing pressure and alignment.

Chuck assembly 508 can be structured and arranged to securely hold and rotate a specific component or container top during the torque application process. Chuck assembly 508 can be equipped with adjustable jaws or grips to accommodate various shapes and sizes of containers and components.

Motor 524 can be controlled (e.g., with torque and speed control) independently from other motors within packaging system 500. For example, motor 521 can be tailored to the specifications and/or requirements of different container sizes, closure types, and production speeds. In an embodiment, motor 521 comprises a pneumatic motor.

A type of motor 521 and/or motor 524 can be selected based on torque and speed characteristics. In examples, motor 521 and/or motor 524 can be equipped with sophisticated torque and speed control mechanisms, allowing precise adjustment of rotational force and speed during the closure application process.

In an embodiment, a torque limiter assembly 506 can each be associated with a corresponding chuck assembly 508. A (e.g., each) motor 521 can be responsible for rotating an associated chuck assembly 508. Chuck assembly 508 can be associated with a single gripping mechanism, such that motor 524 drives the application process for a particular container.

Chuck assembly 508 can optionally include sensor 526. Sensor 526 can indicate a closure status of chuck assembly 508. In an embodiment, sensor 526 is a flow sensor or a pressure sensor.

In an embodiment, motor 521 and/or motor 524 can be commanded by controller 504 using refinement recommendations of refinement engine 521. Refinement engine 521 can be configured to leverage high granularity data associated with packaging system 500 to gain deep insights into patterns, trends, and anomalies that are not be apparent with lower resolution data associated with station-based packaging systems. Advanced techniques, such as machine learning algorithms and data visualization tools, can be employed by refinement engine 521 to extract meaningful insights and improve operations.

In an embodiment, controller 504 can coordinate the operation of individual motors and monitor feedback data, for example from encoder 522 and/or sensor 526. Controller 504 can utilize computational logic to optimize closure application parameters, minimize cycle times, and maximize production throughput of packaging system 500.

In an embodiment, packaging system 500 is configured to operate in conjunction with other feature(s) described herein, including, for example, elements described with respect to FIGS. 1-16.

Various examples of systems, devices, and methods have been described herein. Although features and elements described above are described in particular combinations, each feature or element can be used alone without the other features and elements of the examples or in various combinations with or without other features and elements. For example, while various materials, dimensions, shapes, configurations and locations, etc. have been described for use with disclosed examples, others besides those disclosed can be utilized without exceeding the scope of the claimed inventions.

Persons of ordinary skill in the relevant arts will recognize that the subject matter hereof can comprise fewer features than illustrated in any individual example described above. The examples described herein are not meant to be an exhaustive presentation of the ways in which the various features of the subject matter hereof can be combined. Accordingly, the examples are not mutually exclusive combinations of features; rather, the various examples can comprise a combination of different individual features selected from different individual examples, as understood by persons of ordinary skill in the art. Moreover, elements described with respect to one example can be implemented in other embodiments even when not described in such embodiments unless otherwise noted.

For purposes of interpreting the claims, it is expressly intended that the provisions of 35 U.S.C. § 112(f) are not to be invoked unless the specific terms “means for” or “step for” are recited in a claim.

1. A packaging system for assembling a container, the packaging system comprising:
a chuck assembly including a pneumatic motor, wherein operation of the pneumatic motor causes the chuck assembly to grip a container top positioned proximal to the chuck assembly;
a torque limiter assembly including a servo motor and an encoder, wherein the torque limiter assembly is coupled to the chuck assembly such that operation of the servo motor causes rotation of the chuck assembly; and
a controller communicatively coupled to the chuck assembly and the torque limiter assembly, the controller comprising a memory and at least one processor configured to:
grip the container top using the chuck assembly;
receive, from the encoder, orientation data associated with the chuck assembly;
determine, based on the orientation data, an orientation of an attachment component of the container top relative to a corresponding attachment component of the container;
align the attachment component of the container top and the corresponding attachment component of the container based on the orientation of the attachment component by rotating the chuck assembly using the torque limiter assembly; and
secure the container top to the container by rotating the chuck assembly using the torque limiter assembly such that torque applied to the container top remains below a torque threshold.

2. The packaging system of claim 1 further comprising:
a second chuck assembly; and
a second torque limiter assembly coupled to the second chuck assembly such that the second torque limiter assembly is configured to rotate the chuck assembly, wherein the controller is configured to command the second torque limiter assembly independently from the torque limiter assembly.

3. The packaging system of claim 1, wherein the encoder is an absolute encoder and the orientation data indicates one of a plurality of possible orientations of the chuck assembly.

4. The packaging system of claim 1, wherein the controller is further configured to:
receive feedback data associated with the securement of the container top to the container; and
adjust the torque threshold based on the feedback data.

5. The packaging system of claim 1, wherein the controller is further configured to provide a graphical user interface (GUI) configured to receive the torque threshold from an operator.

6. The packaging system of claim 1, wherein the attachment component of the container top is a threaded portion, and the corresponding attachment component of the container is a corresponding threaded portion.

7. The packaging system of claim 6, wherein alignment of the threaded portion of the container top and the corresponding threaded portion of the container comprises rotating the chuck assembly counterclockwise.

8. The packaging system of claim 1, wherein the container top is a sprayer cap including a diptube.

9. The packaging system of claim 8, wherein the packaging system further comprises a diptube guide assembly for directing the diptube into the container.

10. A method for assembling a container, the method comprising:
griping a container top using a chuck assembly by operating a pneumatic motor associated with the chuck assembly;
positioning the container top proximal to the container;
receiving orientation data associated with the chuck assembly from an encoder;
determining, based on the orientation data, an orientation of an attachment component of the container top relative to a corresponding attachment component of the container;
aligning the attachment component of the container top and the corresponding attachment component of the container based on the orientation of the attachment component by rotating the chuck assembly through operating a servo motor associated with a torque limiter assembly selectively coupled to the chuck assembly; and
securing the container top to the container by operating the servo motor associated with the torque limiter assembly to rotate the chuck assembly such that torque applied to the container top remains below a torque threshold.

11. The method of claim 10, wherein the torque limiter assembly is configured to rotate the chuck assembly independently from a second chuck assembly.

12. The method of claim 10, wherein the encoder is an absolute encoder and the orientation data indicates one of a plurality of possible orientations of the chuck assembly.

13. The method of claim 10, further comprising:
receiving feedback data associated with the securing the container top to the container; and
adjusting the torque threshold based on the feedback data.

14. The method of claim 10, further comprising receiving the torque threshold from a graphical user interface (GUI).

15. The method of claim 10, wherein the attachment component of the container top is a threaded portion, and the corresponding attachment component of the container is a corresponding threaded portion.

16. The method of claim 15, wherein aligning the threaded portion of the container top and the corresponding threaded portion of the container comprises rotating the chuck assembly counterclockwise.

17. The method of claim 10, wherein the container top is a sprayer cap including a diptube.

18. The method of claim 17, further comprising guiding the diptube into the container using a diptube guide assembly.

19. (canceled)

20. (canceled)
